(19) United States
(12) Patent Application Publication
(10) Pub. No.: US 2011/0136441 A1
(43) Pub. Date: Jun. 9, 2011

(54) PORTABLE TERMINAL AND A CONTROL METHOD OF PERIPHERAL DEVICE USING THE SAME

(75) Inventors: Jiyeon Son, Daejeon-city (KR); Changseok Bae, Daejeon-city (KR); Jintae Kim, Daejeon-city (KR)

(73) Assignee: Electronics and Telecommunications Research Institute, Daejeon-city (KR)

(21) Appl. No.: 13/058,125

(22) PCT Filed: Dec. 23, 2008
(86) PCT No.: PCT/KR2008/007595

§ 371 Date: Feb. 8, 2011

(30) Foreign Application Priority Data
Aug. 12, 2008 (KR) 10-2008-0078814

(51) Int. Cl. H04W 4/00

(52) U.S. Cl. 455/70

(57) ABSTRACT

The present invention relates to a portable terminal and a control method of peripheral device using the same. The plurality of peripheral devices adjacent to a portable terminal are searched, the locations of the plurality of searched peripheral devices are measured, a control parameterle value is set to at least one control parameterle for each of the plurality of peripheral devices according to location information of the plurality of peripheral devices, and a control signal including the set control parameterle value is generated and transmitted to a corresponding peripheral device. According to the present invention, in controlling a plurality of adjacent peripheral devices using a portable terminal, the control parameterle values for controlling the individual peripheral devices are changed according to the distances and directions of the plurality of peripheral devices from the portable terminal. Therefore, it is possible to provide customized services optimized on the basis of the location of a user.

### TECHNICAL FIELD

The present invention relates to a portable terminal and a control method of peripheral device using the same, and in particular, to a portable terminal and a control method of peripheral devices around the portable terminal according to the locations of the plurality of peripheral devices.

This work was supported by the IT R&D program of MIC/IITA. [2006-S032-03, Personal-Life-Log-Based Intelligent Service Technique Development]

### BACKGROUND ART

In general, mobile terminals provide various communication services according to approach distances and users select available services according to the distances so as to use the corresponding services.

Further, in order for a mobile terminal to wireless sly communicate with another communication device, the mobile terminal should be within reception state to receive reception frequency information according to a communication arrival distance for each of a plurality of communication devices, such that a communication device to be accessed for wireless communication can be selected, thereby wirelessly communicating with the corresponding communication device.

The above techniques use distance information as a criterion for selecting adjacent peripheral communication devices or services.

However, the above techniques only uses distance information as a criterion for selecting services or communication devices, not for controlling at least one selected service or communication device. Therefore, users should control a corresponding device afresh according to a distance or an angle, which is inconvenience for the user.

Further, techniques for enabling portable terminals to adaptively reproduce stereophonic sound according to the locations of the mobile terminals have been researched. However, those techniques are limited to audio apparatuses which individually require a function to obtain a location of a user.

### DISCLOSURE OF INVENTION

### Technical Problem

An object of the present invention is to provide a portable terminal and a control method of peripheral devices which control a plurality of adjacent peripheral devices on the basis of the location information of the portable terminal and the plurality of peripheral devices so as to provide customized services to users.

### Technical Solution

In order to achieve the above-mentioned object, a portable terminal according to an embodiment of the present invention is a portable terminal for controlling a plurality of peripheral devices and includes a searching unit searching for the plurality of peripheral devices and extracting device information on the plurality of peripheral devices, a location measuring unit measuring the locations of the plurality of searched peripheral devices, and a control unit setting a control variable value for at least one control variable for each of the plurality of peripheral devices according to location information on the peripheral devices, and, when controlling the operation of at least one peripheral device of the plurality of peripheral devices, generating a control signal including the control variable value set for the corresponding peripheral device and transmitting the control signal to the corresponding peripheral device.

The portable terminal may further include a selecting unit selecting at least one peripheral devices of the plurality of peripheral devices to be controlled according to the location information of the peripheral devices measured by the location measuring unit. Here, the selecting unit may classify the plurality of peripheral devices into categories on the basis of the device information extracted by the searching unit. Further, the selecting unit may select any one peripheral device from each classified category.

The control unit may select control variable for which a value is variable according to the location of the peripheral device, on the basis of the device information extracted by the searching unit, and sets the control variable of the control variable.

The location measuring unit may measure the relative locations of the plurality of peripheral devices with reference to the portable terminal. Here, the location information of the peripheral devices may include distance information and/or direction information of the peripheral devices. Meanwhile, the location measuring unit may re-measure the locations of the plurality of peripheral devices at predetermined time intervals, and when the location information on at least one peripheral device is changed, the control variable value of the peripheral device of which location information has been changed may be reset.

Further, the device information on the plurality of peripheral devices includes at least one of a device type and attribute, a control variable type, and a set range of each control variable value.

Meanwhile, a control method of peripheral device using a portable terminal includes searching for the plurality of peripheral devices, measuring the locations of the plurality of searched peripheral devices, setting a control variable value to at least one control variable for each of the plurality of peripheral devices, according to location information of the plurality of peripheral devices, and when controlling the operation of at least one peripheral device of the plurality of peripheral devices, generating a control signal including the control variable value set for the corresponding peripheral device and transmitting the control signal to the corresponding peripheral device.

The control method of peripheral device using a portable terminal may include selecting at least one peripheral device to be controlled from the plurality of peripheral devices according to location information of the plurality of peripheral devices, after the measuring of the locations. Here, the selecting may include classifying the plurality of peripheral devices into categories, and selecting any one peripheral device for each classified category.

Further, in the setting, one or more control variables may be checked on the basis of the device information obtained for the plurality of peripheral devices, a control variable for which a value is variable according to the location of a corresponding peripheral device may be selected from the checked control variables, and a control variable value the selected control variable is set.

Meanwhile, when a predetermined time period elapses after the transmitting is completed, the measuring of the locations may be performed again. Further, when the measuring of the locations is performed again, if the location information of at least one peripheral device of the plurality of peripheral devices is changed, the control variable value of the peripheral device of which the location information has changed may be reset.

### Advantageous Effects

According to embodiments of the present invention, in controlling a plurality of adjacent peripheral devices through a portable terminal, control variables for controlling the individual peripheral devices are changed according to distances and directions of the plurality of peripheral devices from the portable terminal, which makes it possible to provide customized services optimized on the basis of the location of a user.

Further, with respect to the control variables which should be changed according to the distances and direction of the plurality of peripheral devices from a user, since control variable value for a specific peripheral device need not individually be changed as the location of the user is changed, convenience is improved for the user.

### BRIEF DESCRIPTION OF THE DRAWINGS

FIG. 1 and FIG. 2 are drawings illustrating a configuration of a portable terminal according to an embodiment of the present invention;

FIG. 3 is a drawing illustrating an example of category-based peripheral device information according to the embodiment of the present invention;

FIG. 4 is a drawing illustrating the operation of a selecting unit according to the embodiment of the present invention;

FIG. 5 is a drawing illustrating the operation of a control unit according to the embodiment of the present invention; and

FIG. 6 is a flow chart illustrating an operation flow of a portable terminal according to an embodiment of the present invention.

### DESCRIPTION OF REFERENCE NUMERALS REPRESENTING ESSENTIAL PARTS IN THE DRAWINGS

100: Portable terminal 110: Communicating unit
120: Searching unit 130: Location measuring unit
140: Selecting unit 150: Control unit
160: User interface 200: Peripheral device

### BEST MODE FOR CARRYING OUT THE INVENTION

Hereinafter, an embodiment of the present invention will be described with reference to the accompanying drawings.

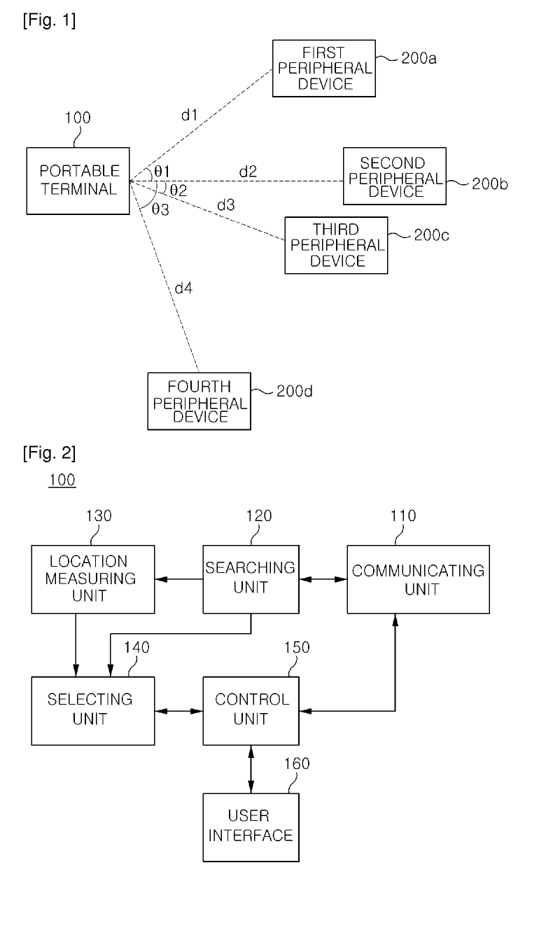

FIG. 1 is a drawing illustrating the connection configuration between a portable terminal and a plurality of peripheral devices according to an embodiment of the present invention. As shown in FIG. 1, a portable terminal 100 according to an embodiment of the present invention can be connected to a plurality of peripheral devices located within a predetermined range, for example, a first peripheral device 200a, a second peripheral device 200b, a third peripheral device 200c, and a fourth peripheral device 200d. In this case, the portable terminal 100 controls each of the plurality of peripheral devices 200a, 200b, 200c, and 200d connected to the portable terminal 100 according to location information thereof.

Examples of the plurality of peripheral devices 200a, 200b, 200c, and 200d include apparatuses, such as a projector, a TV set, an audio player, a speaker, an air conditioner, and an electric fan, which can be remotely controlled through a portable terminal.

Here, location information on the plurality of peripheral devices 200a, 200b, 200c, and 200d includes distance information d1, d2, d3, and d4 and direction information θ1, θ2, θ3, and θ4 of the respective peripheral devices from the portable terminal. When a line extending from the portable terminal 100 in one direction (a direction from the portable terminal to the second peripheral device in the embodiment shown in FIG. 1) serves as a reference axis, the direction information θ1, θ2, θ3, and θ4 represent angles between the reference axis and lines extending from the portable terminal to the respective peripheral devices form.

In this case, the portable terminal 100 may be a fixed or portable terminal and can perform local communication by using WiFi, Bluetooth, Zigbee, RFID, UWB (ultra wide band), infrared light, ultrasonic waves, etc. Further, the plurality of peripheral devices 200a, 200b, 200c, and 200d can perform local communication with the portable terminal 100.

FIG. 2 is a block diagram illustrating a configuration of the portable terminal shown in FIG. 1.

As shown in FIG. 2, the portable terminal 100 according to the embodiment of the present invention includes a communicating unit 110, a searching unit 120, a location measuring unit 130, a selecting unit 140, a control unit 150, and a user interface 160.

The communicating unit 110 includes a module supporting a local communication protocol and transmits/receives wireless signals to/from the plurality of peripheral devices. The wireless signals include at least one of a synchronization signal and a control signal, in which the synchronization signal is for synchronizing the signal with the plurality of peripheral devices and the control signal is for controlling the plurality of peripheral devices. Meanwhile, the communicating unit 110 may include a module for transmitting/receiving a synchronization signal, a module for transmitting/receiving a control signal separately, and/or a separate module for measuring the distances and directions of the peripheral devices from the portable terminal.

The searching unit 120 transmits a wireless signal through the communicating unit 110, receives response signals of the wireless signal from the plurality of peripheral devices, and searches peripheral devices located within a predetermined range by using the response signals. Further, the searching unit 120 generates a peripheral device list on the basis of the search results, and transmits, to the selecting unit 140, the generated peripheral device list and information on individual peripheral devices corresponding to the peripheral device list. Here, the peripheral device information includes at least one of a device type, a device category attribute, a device control variable kind, a device control variable type, and a range of the device control variable value.

Meanwhile, the searching unit 120 transmits, to the location measuring unit 130, information on the wireless signals received from the peripheral devices.

The location measuring unit 130 measures the locations of the peripheral devices on the basis of the wireless signals transmitted from the searching unit 120. In other words, the location measuring unit measures the distances of the peripheral devices in consideration of the response times of the peripheral devices to the signal transmitted to the peripheral devices and signal reception intensity, and measures the directions of the peripheral devices in consideration of the signal reception angles.

Then, the location measuring unit 130 transmits, to the control unit 150, location information measured on the individual peripheral devices. Here, a method of measuring the distances and directions of the peripheral devices may be an existing location measuring method and is not limited to any one method.

The selecting unit 140 selects at least one peripheral device from the peripheral device list transmitted from the searching unit 120. In this case, the selecting unit 140 checks categories of the each peripheral device by using the peripheral device information corresponding to the peripheral device list and classifies the plurality of peripheral devices into categories. Then, the selecting unit 140 selects at least one peripheral device from each category which including at least one peripheral device, and transmits, to the control unit 150, information on the peripheral devices selected from the each category.

Meanwhile, the selecting unit 140 transmits, to the control unit 150, location information, corresponding to the peripheral devices selected from the each category, from among the location informations of the individual peripheral devices transmitted from the location measuring unit 130.

The control unit 150 controls the operations of the selected peripheral devices on the basis of the information and location information on the peripheral devices selected by the selecting unit 140. Further, the control unit 150 determines at least one control variable for every selected peripheral device. In this case, the control variable is determined as a variable for which a value is variable on the basis of the location information.

If determining control variables for every peripheral device, the control unit 150 sets the control variable values according to the location information, i.e., distances and directions, of the individual peripheral devices. In this case, the control variable values are set within variable ranges for the individual control variables. Further, the control unit 150 generates a control message including at least one control variable value set for each peripheral device, and transmits the control message to the corresponding peripheral device.

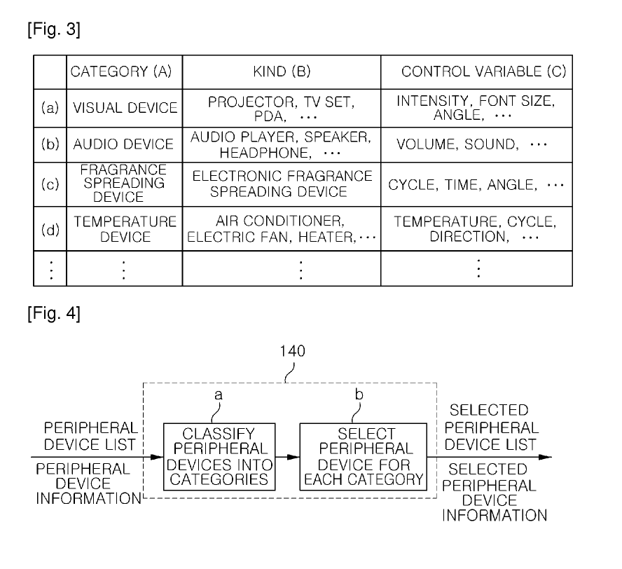

FIGS. 3 to 5 are drawings illustrating the operation of the portable terminal according to the embodiment of the present invention.

FIG. 3 is a drawing illustrating an example of category-based peripheral device information according to the embodiment of the present invention. Referring to FIG. 3, reference symbol ‘A’ represents categories, reference symbol ‘B’ represents kinds of peripheral devices belonging to each of categories ‘A’, and reference symbol'C′ represents control variables for the kinds of peripheral devices T′.

Category A may be classified into visual devices, audio devices, fragrance spreading devices, temperature devices, etc.

Examples of (a) are kinds of peripheral devices belonging to the ‘visual device’ category that may include a projector, a TV set, a PDA, a monitor, a picture frame, etc., and control variables therefor may include intensity, a font size, an angle, etc.

Examples of (b) are kinds of peripheral devices belonging to the ‘audio device’ category that may include an audio player, a speaker, a headphone, etc., and control variables therefor may include volume, a sound, etc.

Examples of (c) are kinds of peripheral devices belonging to the ‘fragrance spreading device’ category that may include an electronic fragrance spreading device, etc., and control variables therefor may include a cycle, time, an angle, etc.

Examples of (d) are kinds of peripheral devices belonging to the ‘temperature device’ category that may include an air conditioner, an electric fan, a heater, a hot air device, etc., and control variables therefor may include a temperature, a cycle, a direction, etc.

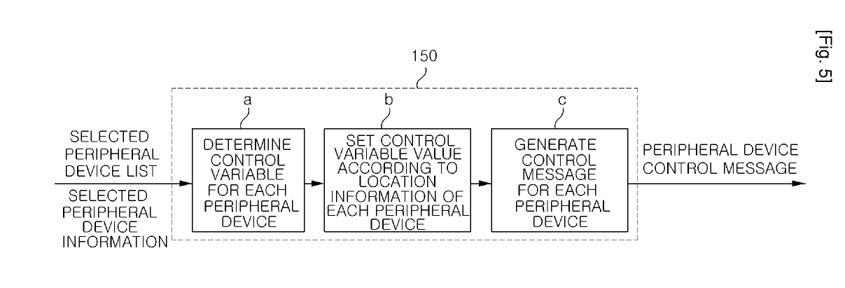

FIG. 4 is a drawing illustrating the operation of the selecting unit according to the embodiment of the present invention. Referring to FIG. 4, if receiving the peripheral device list and information of peripheral devices corresponding to the peripheral device list from the searching unit 120, the selecting unit 140 classifies the peripheral devices into categories on the basis of the received peripheral device information, as exemplified in (a). In this case, the category information of the peripheral devices refers to the example of FIG. 3.

For example, when the peripheral devices included in the peripheral device list are a projector, a TV set, an audio player, and an air conditioner, the projector and the TV set are classified into the ‘visual device’ category, the audio player is classified into the ‘audio device’ category, and the air conditioner is classified into the ‘temperature device’ category.

Further, when the classification of the plurality of peripheral devices into the categories is completed, the selecting unit 140 selects any one peripheral device from the peripheral devices belonging to each category, as exemplified in (b). When a category includes only one peripheral device, the selecting unit 140 directly selects the corresponding peripheral device without a separate procedure.

Meanwhile, when a plurality of peripheral devices belong to a category, one peripheral device is selected on the basis of a separate selection criterion. Here, the same criterion for selecting any one peripheral device may be applied to all categories, or independent criteria may be applied to the individual categories.

For example, a device having the shortest distance and a least angle may be selected. In the case of visual devices, a device having the largest screen may be selected.

The selecting unit 140 transmits a selected peripheral device list and selected peripheral device information to the control unit 150. Here, the selected peripheral device information includes location information of the peripheral devices measured by the location measuring unit 130 and at least one of a device type and attribute, a control variable type, and a set range of each control variable value of each control variable.

FIG. 5 is a drawing illustrating the operation of the control unit according to the embodiment of the present invention. Referring to FIG. 5, if receiving the selected peripheral device list and selected peripheral device information from the selecting unit 140 in FIG. 4, the control unit 150 checks a device type and attribute on the basis of the selected peripheral devices and selected peripheral device information as exemplified in (a), and determines a control variable for every selected peripheral device on the basis of the check results. An example of this determination refers to FIG. 3.

Further, the control unit 150 checks information such as the type of control variable and range of a control variable value determined in (a), and sets the control variable value according to the location information of a corresponding peripheral device as exemplified in (b). At this time, the control unit 150 sets control variable values for the selected peripheral devices.

For example, in the case of a TV set, control variable values of the control variable such as screen brightness, a font size, and an angle of the device are set according to the distance and direction of the TV set. Meanwhile, in the case of an air conditioner, the control variable values of control variables such as the strength and direction of wind and start time are set according to a distance and a direction.

Then, the control unit 150 generates control messages including the control variable values set for each peripheral device in (b), as in (c), and transmits the control messages to corresponding peripheral devices, respectively, thereby controlling the plurality of peripheral devices.

Hereinafter, control method of a peripheral device using a portable terminal according to an embodiment of the present invention will be described in detail with reference to the above-mentioned configuration.

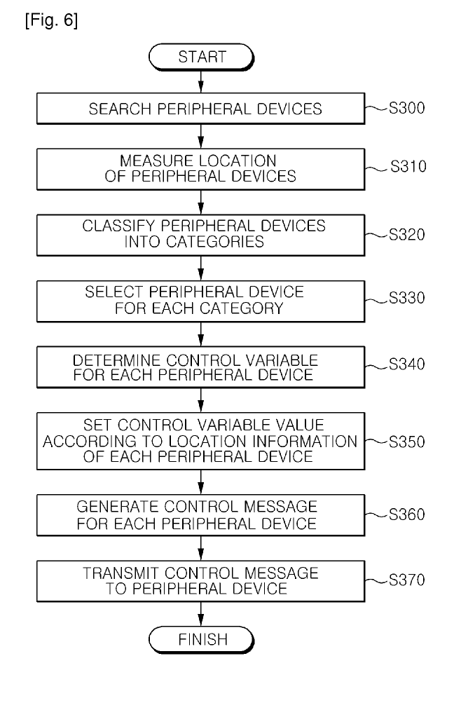

FIG. 6 is a flow chart illustrating an operation flow in control method of a peripheral device using a portable terminal according to an embodiment of the present invention.

Referring to FIG. 6, first, the searching unit 120 transmits a wireless signal through the communicating unit 110 and searches for peripheral devices located within a predetermined range from the portable terminal 100 on the basis of wireless signals received through the communicating unit 110 (S300). A list of the searched peripheral devices and information on the searched peripheral devices are transmitted to the location measuring unit 130 and the selecting unit 140.

Meanwhile, the location measuring unit 130 measures the locations of the plurality of peripheral devices on the basis of the information of the plurality of peripheral devices received from the searching unit 120 (S310). The location informations on the measured of the plurality of peripheral devices are transmitted to the selecting unit 140.

When receiving a list of the plurality of peripheral devices and information on the plurality of peripheral devices from the searching unit 120 and the location measuring unit 130, the selecting unit 140 reads the list of the plurality of peripheral devices and the information of the plurality of peripheral devices and classifies the plurality of peripheral devices into categories (S320). Here, the selected peripheral device information includes a device type and attribute information, a control variable, and a type, attribute, and range of control variable value. Further, the selected peripheral device information includes location information of individual peripheral devices measured by the location measuring unit 130.

Then, any one of the peripheral devices belonging to each of the classified categories is selected (S330). Here, the same criterion for selecting any one peripheral device may be applied to all categories, or independent criteria may be applied to the individual categories. A list of the selected peripheral devices and information on the selected peripheral devices are transmitted to the control unit 150.

Meanwhile, the control unit 150 reads the list of peripheral devices selected by the selecting unit 140 and the information on the individual peripheral devices corresponding to the list, and determines control variables for every selected peripheral device (S340). Then, the control unit 150 sets values of the control variables on the basis of the location information of the selected peripheral devices (S350). Here, since the location information of the peripheral devices includes distance information and/or direction information of the peripheral devices, the control unit 150 sets the control variable values according to the distances and directions of the peripheral devices. In this case, the control variable values are set for each peripheral device.

Further, when controlling the operation of at least one peripheral device of the plurality of peripheral devices, the control unit 150 generates control messages including the control variable values set for every corresponding peripheral device (S360), and transmits the control messages to corresponding peripheral devices through the communicating unit 110 (S370). Therefore, the selected peripheral devices are controlled by the control variable values set according to the distances and directions.

Meanwhile, when the measuring of the locations is performed again, if the location information on at least one peripheral device of the plurality of peripheral devices is changed, the control variable value of the peripheral device of which the location information has changed is reset.

As described above, the portable terminal and control method of the peripheral device using the same according to the embodiments of the present invention have been described with reference to the illustrative drawings. However, the present invention is not limited to the embodiments and drawings disclosed in this specification but can be modified within a range in which the technical idea is protected.

1. A portable terminal for controlling a plurality of peripheral devices, comprising:
a searching unit searching for the plurality of peripheral devices and extracting device information on the plurality of peripheral devices;
a location measuring unit measuring the locations of the plurality of searched peripheral devices, and
a control unit setting a control variable value for at least one control variable for each of the plurality of peripheral devices according to location information on the peripheral devices, and, when controlling the operation of at least one of the plurality of peripheral devices, generating a control signal including the control variable value set for the corresponding peripheral device and transmitting the control signal to the corresponding peripheral device.

2. The portable terminal according to claim 1, further comprising:
a selecting unit selecting at least one of the plurality of peripheral devices to be controlled according to the location information of the peripheral devices measured by the location measuring unit.

3. The portable terminal according to claim 2, wherein
the selecting unit classifies the plurality of peripheral devices for into categories on the basis of the device information extracted by the searching unit.

4. The portable terminal according to claim 3, wherein
the selecting unit selects any one peripheral device for each classified category.

5. The portable terminal according to claim 1, wherein
the control unit selects a control variable for which a value is variable according to the location of the peripheral device, on the basis of the device information extracted by the searching unit and sets the control variable value of the control variable.

6. The portable terminal according to claim 1, wherein
the location measuring unit measures the relative locations of the plurality of peripheral devices with reference to the portable terminal.

7. The portable terminal according to claim 1, wherein
the location information of the peripheral devices includes at least one of distance information and/or direction information of the peripheral devices.

8. The portable terminal according to claim 1, wherein
the device information on the plurality of peripheral devices includes at least one of a device type and attribute, a control variable type, and a set range of each control variable value.

9. The portable terminal according to claim 1, wherein
the location measuring unit re-measures the locations of the plurality of peripheral devices at predetermined time intervals.

10. The portable terminal according to claim 1, wherein
when the location information on at least one peripheral device is changed, the control unit resets the control variable value of the peripheral device of which location information has been changed.

11. A control method of peripheral device using a portable terminal, comprising:
searching for the plurality of peripheral devices;
measuring the locations of the plurality of searched peripheral devices;
setting a control variable value to at least one control variable for each of the plurality of peripheral devices, according to location information of the plurality of peripheral devices; and
when controlling the operation of at least one peripheral device of the plurality of peripheral devices, generating a control signal including the control variable value set for the corresponding peripheral device and transmitting the control signal to the corresponding peripheral device.

12. The control method of peripheral device using a portable terminal according to claim 11, further comprising:
after the measuring of the locations, selecting at least one peripheral device to be controlled from the plurality of peripheral devices according to location information of the plurality of peripheral devices.

13. The control method of peripheral device using a portable terminal according to claim 12, wherein
the selecting includes
classifying the plurality of peripheral devices into categories, and
selecting any one peripheral device for each of the classified categories.

14. The control method of peripheral device using a portable terminal according to claim 11, wherein
in the setting, one or more control variables are checked on the basis of the device information obtained for the plurality of peripheral devices, a control variable for which a value is variable according to the location of a corresponding peripheral device is selected from the checked control variables, and a control variable value of the selected control variable is set.

15. The control method of peripheral device using a portable terminal according to claim 11, wherein
the measuring the position is performed again when a predetermined time period elapses after the transmitting is completed.

16. The control method of peripheral device using a portable terminal according to claim 15, wherein
when the measuring of the locations is performed again, if the location information on at least one peripheral device of the plurality of peripheral devices is changed, the control variable value of the peripheral device of which the location information has changed is reset.
